(19) United States
(12) Patent Application Publication
(10) Pub. No.: US 2026/0117695 A1
(43) Pub. Date: Apr. 30, 2026

(54) EPIC Cycles for the EPIC Cycle Engine

(71) Applicant: William Gregory Buchanan, King George, VA (US)

(72) Inventor: William Gregory Buchanan, King George, VA (US)

(73) Assignee: United States of America, as represented by the Secretary of the Navy, Arlington, VA (US)

(21) Appl. No.: 18/963,875

(22) Filed: Nov. 29, 2024

Related U.S. Application Data
(63) Continuation of application No. 16/831,023, filed on Mar. 26, 2020, now Pat. No. 12,168,954.

(51) Int. Cl. F02B 53/12; F01C 1/22; F01L 1/18; F02B 53/00; F02B 53/04; F02B 53/06; F02B 55/00; F02B 55/02; F02B 55/08; F02B 55/14

(52) U.S. Cl. CPC F02B 53/12; F01C 1/22; F01L 1/18; F02B 53/00; F02B 53/04; F02B 53/06; F02B 55/00; F02B 55/02; F02B 55/08; F02B 55/14

(57) ABSTRACT

A rotary engine is provided, comprising a planar housing with a circular center cavity, a pair of rotary wall valves flanking and overlapping the circular center cavity and centered on an axis extending through the circular center cavity, a truncated ellipsoid rotor rotatably mounted within the circular center cavity, and fore and aft cover plates flanking the planar housing.

### CROSS-REFERENCE TO RELATED APPLICATIONS

The invention is a Continuation of, claims prior to and incorporates by reference entirely U.S. patent application Ser. No. 18/772,368 filed Jul. 15, 2020 and assigned Navy Case 211375-2 and U.S. patent application Ser. No. 16/831,023 filed Mar. 26, 2020 and assigned Navy Case 108378.

### FEDERALLY SPONSORED RESEARCH AND DEVELOPMENT

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### INCORPORATION BY REFERENCE

The disclosure of “NOVEL HIGH POWER DENSITY ENGINE FOR MILITARY APPLICATION” by Christopher Lamb at the University of Maryland, published on Nov. 29, 2023, is hereby incorporated by reference in its entirety.

### SUMMARY OF THE INVENTION

The EPIC Cycle (modified Exhaust-Power-Intake-Compression strokes) Engine is a family of engine versions based on the modification of cycles into a complex yet elegant new multi-variant cycle, and the application of technology to capitalize on those cycle modifications of these new EPIC [Buchanan] Cycles. The EPIC Engine Family includes the EPIC Generator and other and offspring products/applications/variations. The EPIC Cycles include, but are not limited to, simultaneous strokes, shared space, maximized leverage, conservation of motion, transference of compressed gasses from the leading to trailing sides of pistons and/or wall valves for combustion, specific power/power density (SP/PD) increase with addition of pistons and wall valves, along with temporal compressed gas storage. The EPIC Cycle Engine Family utilizes any hardware configuration, along with supporting HW and SW to enable the EPIC Cycle and other key aspects of the EPIC Engines. The Buchanan Cycle can be ordered in several ways for application to various versions of the EPIC Engines. The EPIC [Buchanan] Engine utilizes Wall Valve(s) [(WV), i.e. movable cylinder head(s)] to reach far into and out of cylinder(s) thus increasing internal engine volume beyond that which would otherwise be possible, along with internal, external and sandwiched compression tunnels within, through or between any components for partial to full compressed gasses transference. The Buchanan Engine also increases power at some exponential rate by adding WVs and piston lobes in its shared internal volume and that SP/PD gain over comparable piston engines is proportional to the number of pistons. The physical number of cylinders is equal to the number of pistons. The equivalent number of cylinders is defined by the multiplicative equation of the # pistons times the # of WVs. The number of power strokes per revolution is the equivalent number of cylinders divided by 2.

Conventional rotary engines yield disadvantages addressed by various exemplary embodiments of the present invention. In particular, various exemplary embodiments provide a rotary engine to produce torque. The engine includes a planar housing, a truncated ellipsoid rotor, a pair of double-concave blades, fore and aft cover plates, and a gear box. The housing has a circular main cavity, and a pair of circular lateral cavities overlapping the main cavity and disposed along a longitudinal axis. The rotor is disposed within the main cavity on a rotor shaft along a rotation axis perpendicular to the planar housing.

The blades flank the rotor and are disposed within their corresponding lateral cavity and turn on corresponding blade shafts parallel to the rotor shaft. The fore and aft cover plates flank the housing along the rotation axis to cover the center and lateral cavities. The gear box is disposed on the aft cover plate and has a rotor gear wheel with adjacent corresponding blade gear wheels. The rotor gear wheel turns with the rotor shaft while engaging both blade gear wheels along their peripheries. The blade gear wheels turn with the corresponding blade shafts. The blades turn opposite to the rotor.

Another aspect of the present disclosure is that the stroke order may be varied. In the Buchanan Cycle the EPIC strokes may be varied to occur in 24 combinations. The strokes may occur in any of the following variations: EPIC, EPCI, EICP, EIPC, ECPI, ECIP, PECI, PEIC, PICE, PIEC, PCIE, PCEI, IECP, IEPC, ICEP, ICPE, IPCE, IPEC, CEIP, CEPI, CPEI, CPIE, CIEP, or CIPE. Further, the EPIC Cycle combines 2 strokes at a time as part of it's modification of each standard cycle (e.g. IPCE combines IP on one side of a rotor with CE on the other side).

Another aspect of the present disclosure is that the rotary engine may be operated in a modified diesel EPIC Cycle. In the modified diesel EPIC Cycle, the diesel four-stroke two piston two WV EPIC ignites under pressure on one end (at one rotary wall valve) every ½ revolution or 2 times per revolution. The diesel cycle continues to progress as the trapped gasses move from volume to volume (8 total) as the rotor spins around, completing two revolutions. Adding pistons increases the power density as well as the complexity of the cycle. In some embodiments, the engine may include a supercharger to increase the flow of air into the intake to facilitate the modified diesel EPIC Cycle.

Another aspect of the present disclosure is that the EPIC Cycle may be modified as a two stroke cycle. In a two-stroke two piston two WV EPIC (Otto, Diesel, etc.) the engine would fire on both ends (at both rotary wall valves) every ½ revolution or 4 times per revolution. It is possible for a two stroke engine of any type to double the power of its four-stroke counterpart if a full set of air is brought in and extraneous exhaust is driven out to the same levels as for the four-stroke version. While doubling the power is theoretically possible some inherent inefficiencies in a two-stroke engine may limit the power to less than double. In some embodiments, the engine may be augmented to include a supercharger to increase the flow of air into the intake. From about ½ to ¾ through the power stroke the exhaust and intake ports would open with the augmented air forcing the exhaust out and pre-compressing the chamber (happening on both sides of the rotor at same time). Both ports would then close for the completion of compression up to Top Dead Center (TDC) and then the next ‘2-top and bottom’ power strokes occur, and repeat over and over. The port may be opened either by the passage of the rotor revealing the ports and/or via electro-mechanical means. Adding pistons increases the power density as well as the complexity of the cycle.

In another embodiment of the present disclosure, the rotary engine may be operated in an Atkinson cycle for increase engine efficiency. In an Atkinson cycle, the Rotary Wall Valve (RWV) EPIC has less air intake, and hence effectively a shorter intake stroke and effectively a shorter compression stroke than the effective expansion stroke. This can be accomplished by adjusting the intake, bleed, and exhaust port mechanisms.

### BRIEF DESCRIPTION OF DRAWINGS

FIG. 1 shows a cross section of a piston of an EPIC Engine;

FIG. 2 shows a method of operating the EPIC Engine;

FIG. 3 shows a rudimentary 1 cylinder engine model;

FIG. 4 shows method of operating the EPIC Engine using the model;

FIG. 5A illustrates the gas mixing over the first revolution of the engine;

FIG. 5B illustrates the gas mixing over the second revolution of the engine;

FIG. 5C illustrates the gas mixing over the third revolution of the engine; and

FIG. 5D illustrates the gas mixing over the fourth revolution of the engine.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced.

These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

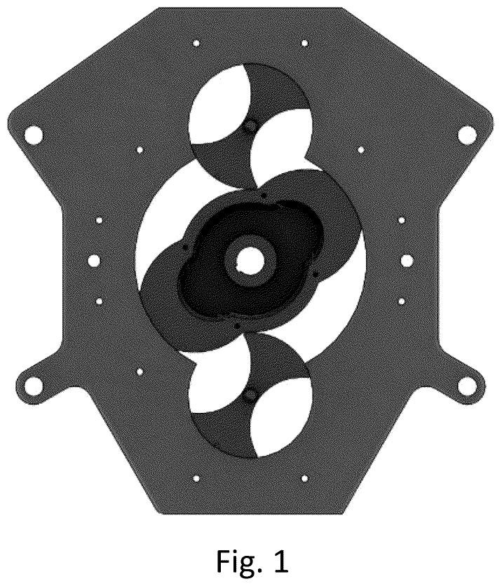

FIG. 1 shows a cross section of a piston of an EPIC Engine. An Epic Engine is a bilateral rotary combustion engine that includes an engine housing, an intake, an exhaust, a truncated ellipsoid rotor, an upper rotary wall valve, and a lower rotary wall valve. As shown the truncated ellipsoid rotor spins about a shaft and interacts with the pair of rotary wall valves to produce power. The Epic Engine may include a plurality of pistons connected to the shaft to increase the power output.

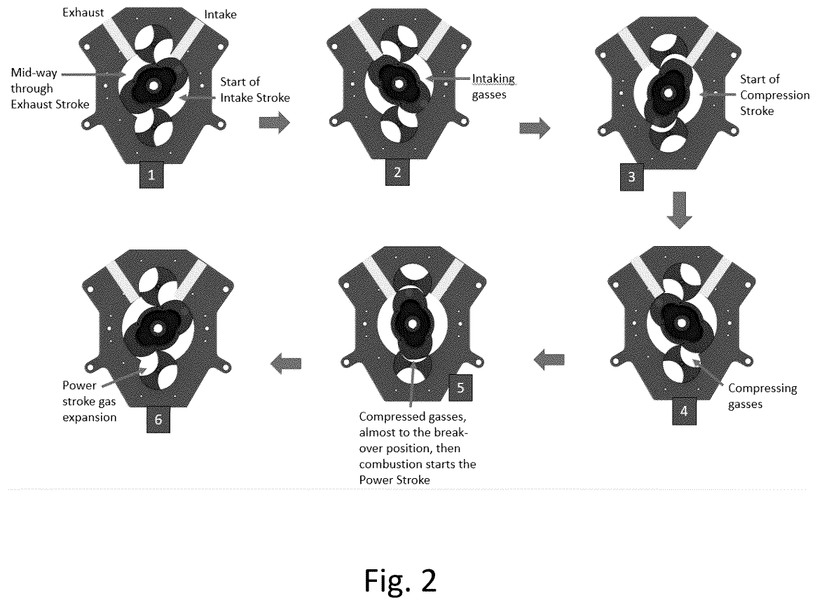

FIG. 2 shows a method of operating the EPIC Engine. In Step 1, an intake stroke begins when a first end of the truncated ellipsoid rotor uncovers the intake. In step 2, the intake stroke continues intaking gasses. In step 3, the intake stroke ends when the first end of the truncated ellipsoid rotor passes the lower chamber of the engine, and a compression stroke begins as the first end of the truncated ellipsoid rotor passes the lower chamber of the engine. In step 4, the gasses are compressed between a second end of the truncated ellipsoid rotor and a lower rotary wall valve. In the upper RWV, a portion of gas from the intake volume bypasses the power producing area to be transferred to the exhaust volume. Also in the upper RWV, a portion of the combustion products are transferred from the exhaust volume to the intake volume. In step 5, the compression stroke ends when the first end of the truncated ellipsoid rotor approaches a center of the upper chamber (also called the break-over position), wherein the gasses are compressed between the truncated ellipsoid rotor and a first cavity on the rotary wall valve. In step 6, a power stroke that begins as the first end of the truncated ellipsoid rotor passes the center of the upper chamber and ending when the first end of the truncated ellipsoid rotor passes the intake.

Variable Stroke Order: The engine may operate with a variable stroke order, including 24 combinations of EPIC strokes, such as EPIC, EPCI, EICP, EIPC, ECPI, ECIP, PECI, PEIC, PICE, PIEC, PCIE, PCEI, IECP, IEPC, ICEP, ICPE, IPCE, IPEC, CEIP, CEPI, CPEI, CPIE, CIEP, or CIPE.

Modified Diesel EPIC Cycle: The engine may operate in a modified diesel EPIC Cycle, where the diesel four-stroke two piston two WV EPIC ignites under pressure on one end every ½ revolution or 2 times per revolution. The diesel cycle continues to progress as the trapped gasses move from volume to volume (8 total) as the rotor spins around, completing two revolutions. Adding pistons increases the power density as well as the complexity of the cycle. In some embodiments, the engine may include a supercharger to increase the flow of air into the intake to facilitate the modified diesel EPIC Cycle.

Two-Stroke Cycle: The engine may operate in a two-stroke cycle, where the engine fires on both ends (at both rotary wall valves) every ½ revolution or 4 times per revolution. It is possible for a two stroke engine of any type to double the power of its four-stroke counterpart if a full set of air is brought in and extraneous exhaust is driven out to the same levels as for the four-stroke version. While doubling the power is theoretically possible, some inherent inefficiencies in a two-stroke engine may limit the power to less than double. In some embodiments, the engine may be augmented to include a supercharger to increase the flow of air into the intake.

Atkinson Cycle: The engine may operate in an Atkinson cycle, where the Rotary Wall Valve (RWV) EPIC via less air intake and less of a compression stroke than expansion stroke can be accomplished by adjusting the intake, bleed, and exhaust port mechanisms.

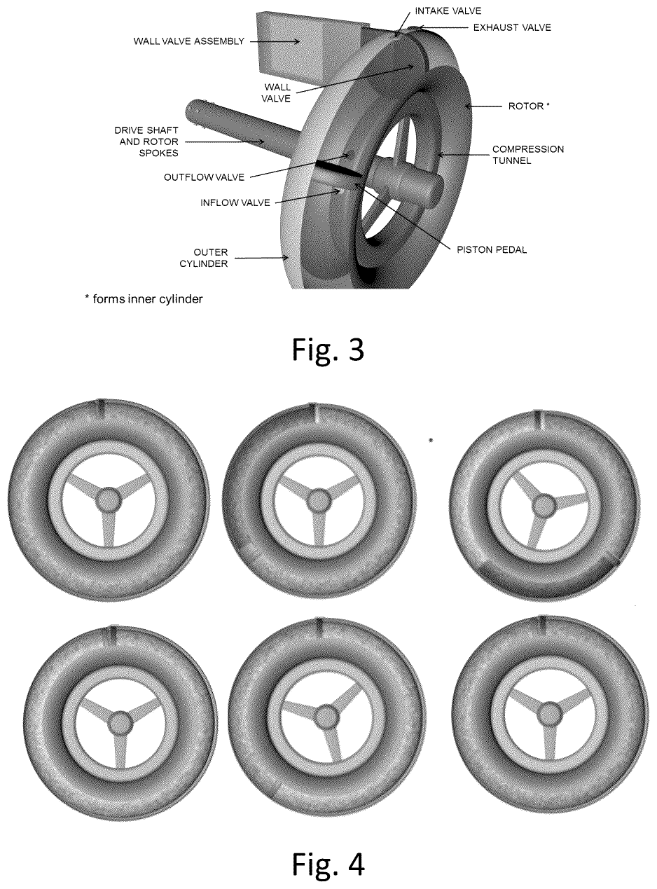

FIG. 3 shows a rudimentary 1 cylinder engine model. This is a model of the EPIC engine that is used to further describe the EPIC Cycle. In this model of the EPIC engine, the model depicts a drive shaft, rotor spokes, a rotor which forms the inner cylinder, an outer cylinder, a wall valve assembly, an intake valve, an exhaust valve, an outflow valve, an inflow valve, a piston, and a compression tunnel.

FIG. 4 shows method of operating the EPIC Engine using the model. In Step 1, the majority of the compression tunnel is filled with a compressed fuel-air mixture and the cylinder is filled with an uncompressed air fuel mixture. In step 2, the previously compressed gas is released from the compression tunnel and ignited to burn and expands pushing the piston. In step 3, the fuel air mixture continues to burn and push the piston leaving behind combusted compressed gasses, while compressing the fuel air mixture in front of it and pushing this compressed mixture into the compression tunnel. In step 4, the combusted compressed gasses finish expanding to push the piston back to the top of the compression tunnel to begin a second rotation and the compression tunnel is again filled with a compressed fuel air mixture. In step 5, uncompressed fuel air mixture is drawn into the cylinder behind the piston and the exhaust is pushed out in front of the piston, while the compression tunnel remains closed. In step 6, the entire cylinder is filled with the uncompressed air fuel mixture ready to begin the method again.

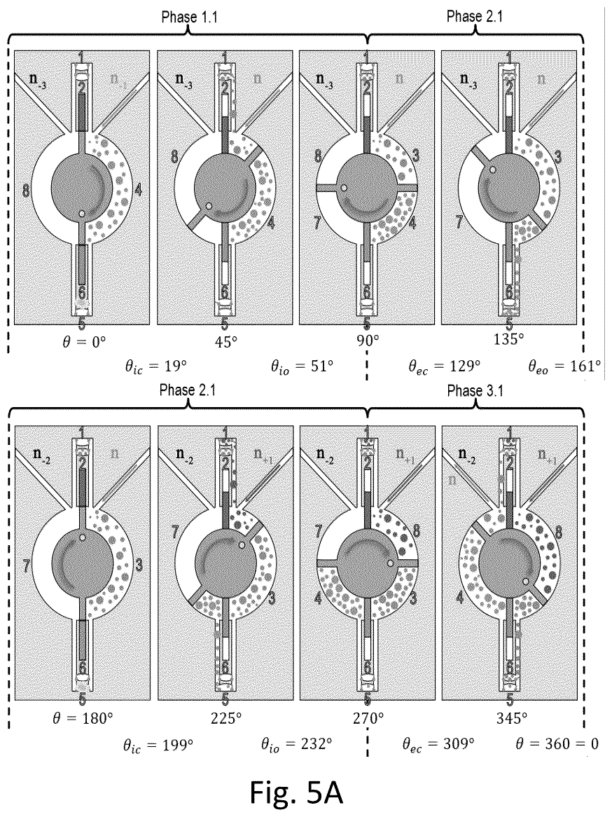

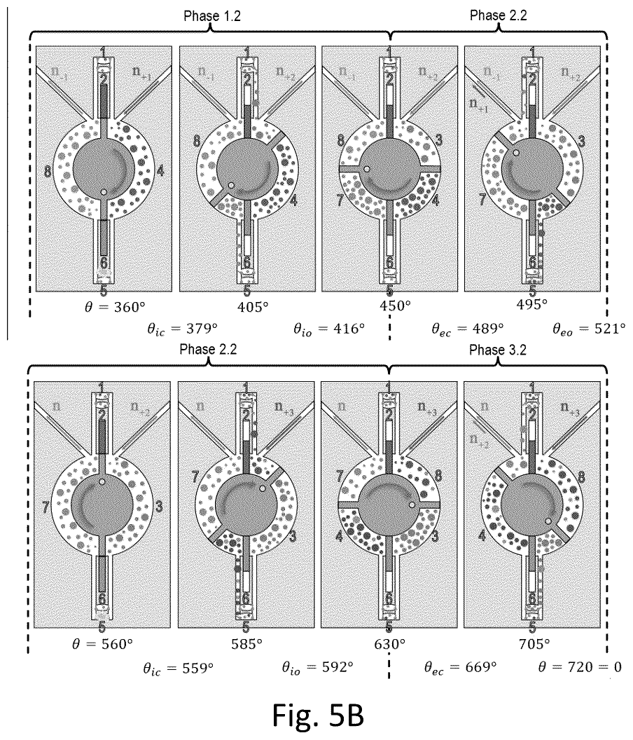

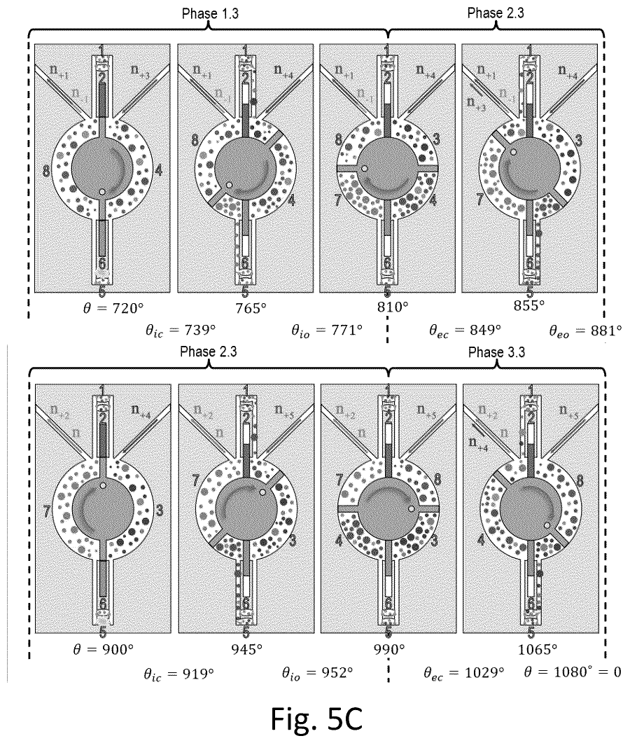

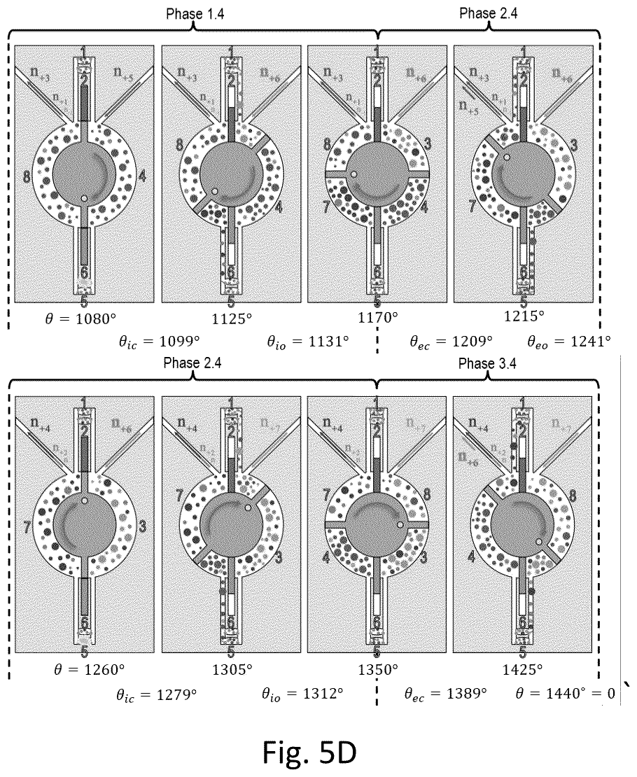

As described in “NOVEL HIGH POWER DENSITY ENGINE FOR MILITARY APPLICATION” by Christopher Lamb, one of the interesting features of the EPIC engine is that its multiple lobes function as multiple “volumes” in a conventional piston engine. However, unlike in a piston engine, the behavior of the valves allows gases (especially exhaust) to be transferred between separate “cylinders”. This is illustrated in FIG. 5, which shows a montage of the EPIC cycle.

In FIG. 5A-D, the main rotor turns clockwise while the meshing wall valves move in and out. Blue arrows show the direction of flow into the intake ports while red arrows show the direction of exhaust flow. The subscripts (n−2, n−1, n, n+1, n+2) indicate which cycle the particular flow is associated with. For example, n refers to the cycle beginning at θ=0°, n+1 refers to the cycle that comes after n, n−1 refers to the previous cycle, n−2 refers to 2 cycles prior, etc.

As shown in FIG. 5A, at θ=0°, the intake stroke for the nth cycle is nearly complete and the exhaust stroke for the n−2th cycle is just beginning. The jagged yellow region indicates initiation of combustion and expansion of hot products. The labeling convention for the phases in the figures is “Phase A. B” where A gives the phase in the cycle and B gives the cycle number or crankshaft revolution. So “Phase 2.3” refers to phase 2 of the third crankshaft revolution.

The EPIC engine's ability to transfer gases between separate “volumes” allows for improved efficiency and power density. The engine can be optimized for performance by adjusting the intake, bleed, and exhaust port mechanisms, using a supercharger, turbocharger, and other enhancers, and the performance can be multiplied by adding pistons. The EPIC engine is suitable for a variety of applications, including automotive, industrial, and aerospace applications.

1. (canceled)

2. (canceled)

3. (canceled)

4. (canceled)

5. (canceled)

6. (canceled)

7. (canceled)

8. A rotary engine comprising:
a planar housing with a circular center cavity;
a first and a second rotary wall valve flanking and overlapping said circular center cavity;
a truncated ellipsoid rotor rotatably mounted within said circular center cavity; and
fore and aft cover plates flanking said planar housing.

9. (canceled)

10. (canceled)

11. (canceled)

12. The rotary engine of claim 8, wherein each rotary wall valve further comprises a double-concave blade rotatably mounted within a circular cavity.

13. The rotary engine of claim 8, further comprising at least one intake and at least one exhaust, each comprising an opening from outside said rotary engine to said circular center cavity; wherein:
said first and said second rotary wall valves are centered on an axis extending through said circular center cavity; and
said at least one intake and said at least one exhaust are disposed on opposite sides of said axis.

14. The rotary engine of claim 8, wherein said truncated ellipsoid rotor is affixed to a rotor shaft.

15. The rotary engine of claim 12, wherein each double-concave blade is affixed to a blade shaft.

16. The rotary engine of claim 8, further comprising:
a gear box disposed on said aft cover plate; and
a rotor gear wheel with adjacent corresponding blade gear wheels disposed within said gear box; wherein:
said rotor gear wheel turns with a rotor shaft while engaging both blade gear wheels; and
said blade gear wheels correspondingly turn blade shafts.

17. A method for operating a rotary engine, said method comprising:
introducing a gas and fuel mixture into a circular center cavity of a planar housing through an intake;
compressing said mixture from said circular center cavity into a first rotary wall valve;
combusting said mixture in said first rotary wall valve;
expanding combustion products from said first rotary wall valve into said circular center cavity; and
expelling said combustion products from said circular center cavity to outside said rotary engine through an exhaust.

18. The method of claim 17, wherein said first rotary wall valve and a second rotary wall valve flank and overlap said circular center cavity, and are centered on an axis extending through said circular center cavity.

19. The method of claim 18, wherein said first and second rotary wall valves each comprise a double-concave blade rotatably mounted within a circular cavity.

20. The method of claim 18, wherein at least one intake and at least one exhaust each comprise an opening from outside said rotary engine to said circular center cavity, disposed on opposite sides of said axis.

21. The method of claim 17, wherein:
said mixture is compressed from said circular center cavity into a second rotary wall simultaneously with said compressing into said first rotary wall valve;
said mixture is combusted in said second rotary wall valve simultaneously with said combusting in said first rotary wall valve; and
said combustion products are expanded from said second rotary wall valve into said circular center cavity simultaneously with said expanding from said first rotary wall valve.

22. The method of claim 17, further comprising transferring a portion of said gas and fuel mixture from an intake volume to an exhaust volume by a second rotary wall valve, with said portion bypassing said compression and said combustion.

23. The method of claim 17, further comprising transferring a portion of said combustion products from said exhaust volume to said intake volume by a second rotary wall valve.

24. The method of claim 17, wherein a truncated ellipsoid rotor is rotatably mounted within said circular center cavity.

25. The method of claim 17, wherein said rotary engine is operated using a modified diesel Exhaust-Power-Intake-Compression (EPIC) Cycle, such that combusting under pressure occurs at said first rotary wall valve every ½ revolution or 2 times per revolution.

26. The method of claim 18, wherein said rotary engine is operated using a two-stroke cycle, such that combusting occurs at said first and said second rotary wall valves every ½ revolution or 4 times per revolution.

27. The method of claim 17, wherein said rotary engine is operated using an Atkinson cycle by adjusting said intake, said exhaust, and a bleed port mechanism, such that an expansion stroke is effectively longer than a compression stroke and an intake stroke.

28. A method for operating a rotary engine, said method comprising:
introducing a gas and fuel mixture into a circular center cavity of a planar housing through an intake;
compressing said mixture from said circular center cavity into said first rotary wall valve using a truncated ellipsoid rotor, wherein
said truncated ellipsoid rotor is rotatably mounted within said circular center cavity;
said first rotary wall valve and a second rotary wall valve flank and overlap said circular center cavity, and are centered on an axis extending through said circular center cavity; and
said rotary wall valves each comprise a double-concave blade rotatably mounted within a circular cavity;
combusting said mixture in said first rotary wall valve;
expanding combustion products from said first rotary wall valve into said circular center cavity; and
expelling said combustion products from said circular center cavity to outside said rotary engine through an exhaust, wherein at least one intake and at least one exhaust each comprise an opening from outside said rotary engine to said circular center cavity, disposed on opposite sides of said axis.

29. The method of claim 28, wherein:
said mixture is compressed from said circular center cavity into said second rotary wall valve simultaneously with said compressing into said first rotary wall valve;
said mixture is combusted in said second rotary wall simultaneously with said combusting in said first rotary wall valve; and
said combustion products are expanded from said second rotary wall valve into said circular center cavity simultaneously with said expanding from said first rotary wall valve.

30. The method of claim 28, further comprising:
transferring a portion of said gas and fuel mixture from an intake volume to an exhaust volume by said second rotary wall valve, with said portion bypassing said compression and said combustion; and
transferring a portion of said combustion products from said exhaust volume to said intake volume by said second rotary wall valve.
